(19) United States
(12) Patent Application Publication
(10) Pub. No.: US 2026/0095533 A1
(43) Pub. Date: Apr. 2, 2026

(54) IMAGE PROCESSING APPARATUS, METHOD OF CONTROLLING IMAGE PROCESSING APPARATUS, AND STORAGE MEDIUM

(71) Applicant: CANON KABUSHIKI KAISHA, Tokyo (JP)

(72) Inventors: KAZUHISA FUJINO, Kanagawa (JP); MASAO MAEDA, Kanagawa (JP); NAOKI SHIMADA, Kanagawa (JP); YOSHINORI MIZOGUCHI, Tokyo (JP); HIROYUKI HOSOGOSHI, Kanagawa (JP); SAKI NARUSHIMA, Kanagawa (JP)

(21) Appl. No.: 19/339,529

(22) Filed: Sep. 25, 2025

(30) Foreign Application Priority Data
Sep. 30, 2024 (JP) 2024-170265

(51) Int. Cl. H04N 1/00; G06F 3/12; H04N 1/38; H04N 1/60

(52) U.S. Cl. CPC H04N 1/00896; G06F 3/1204; G06F 3/1221; G06F 3/1229; G06F 3/1255; H04N 1/00413; H04N 1/0044; H04N 1/38; H04N 1/6094; G06F 3/1292; H04N 2201/0094

(57) ABSTRACT

An image processing apparatus includes one or more processors and/or circuitry which function as: an obtaining unit configured to obtain a cumulative amount of power consumption for each of job types in a predetermined period; and a display control unit configured to display the cumulative amount of power consumption for each of the job types obtained by the obtaining unit on a display device.

### BACKGROUND

### Field of the Technology

The present disclosure relates to an image processing apparatus for presenting the amount of power consumption.

### Description of the Related Art

Japanese Patent Laid-Open No. 2023-104559 (hereinafter referred to as Document 1) discloses an image processing apparatus which sets a threshold value for the amount of power consumption of the image processing apparatus and displays a warning in a case where the amount of power consumed by the image processing apparatus in use exceeds the set threshold value.

The amount of power consumption of an image processing apparatus varies according to its operation status. For this reason, there is a need to know the actual amount of power consumption. However, the technology of Document 1 described above can only detect that a predetermined amount of power consumption is exceeded, and cannot satisfy the above need.

### SUMMARY

An image processing apparatus according to the present disclosure includes one or more processors and/or circuitry which function as: an obtaining unit configured to obtain a cumulative amount of power consumption for each of job types in a predetermined period; and a display control unit configured to display the cumulative amount of power consumption for each of the job types obtained by the obtaining unit on a display device.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a configuration of a system 100 according to a first embodiment.

FIG. 2 is a block diagram illustrating a configuration of a control system of a printer 130.

FIG. 3 is a perspective view illustrating an exterior of the printer 130.

FIG. 4A is a diagram illustrating an example of a screen displayed on an operation panel 203 of the printer 130.

FIG. 4B is a diagram illustrating an example of a screen displayed on the operation panel 203 of the printer 130.

FIG. 4C is a diagram illustrating an example of a screen displayed on the operation panel 203 of the printer 130.

FIG. 4D is a diagram illustrating an example of a screen displayed on the operation panel 203 of the printer 130.

FIG. 4E is a diagram illustrating an example of a screen displayed on the operation panel 203 of the printer 130.

FIG. 4F is a diagram illustrating an example of a screen displayed on the operation panel 203 of the printer 130.

FIG. 5A is a diagram illustrating an example of a screen that displays a list of histories of print jobs.

FIG. 5B is a diagram illustrating an example of the screen that displays the list of histories of the print jobs.

FIG. 5C is a diagram illustrating an example of a screen that displays a history of a print job.

FIG. 6A is a diagram illustrating an example of a screen that displays a list of histories of scan jobs.

FIG. 6B is a diagram illustrating an example of the screen that displays the list of histories of the scan jobs.

FIG. 6C is a diagram illustrating an example of a screen that displays a history of a scan job.

FIG. 7A is a diagram illustrating an example of a screen that displays a list of histories of copy jobs.

FIG. 7B is a diagram illustrating an example of the screen that displays the list of histories of the copy jobs.

FIG. 7C is a diagram illustrating an example of a screen that displays a history of a copy job.

FIG. 8 is a diagram illustrating a data structure stored in a non-volatile memory 215.

FIG. 9 is a diagram illustrating a menu configuration and setting items on the operation panel 203 of the printer 130.

FIG. 10 is a diagram describing software processing blocks in a case of executing printing and scanning.

FIG. 11 is a table summarizing the amount of power consumption of the printer 130 that varies according to an operating status of the printer 130.

FIG. 12 is a flowchart illustrating contents of processing by a central processing unit (CPU) 211 of the printer 130.

FIG. 13 is a diagram describing software processing blocks in a case of executing printing and scanning.

FIG. 14 is a diagram describing software processing blocks in a case of executing printing and scanning.

FIG. 15 is a flowchart illustrating contents of processing by the CPU 211 of the printer 130.

FIG. 16 is a diagram illustrating an electrical circuit configuration for measuring the amount of power consumption of the printer 130 during operation.

FIG. 17 is a flowchart illustrating contents of processing for calculating the amount of power consumption of the printer 130.

FIG. 18A is a diagram illustrating a display example of a screen with a suggestion for reducing power consumption that is displayed during printing.

FIG. 18B is a diagram illustrating a display example of a screen with the suggestion for reducing power consumption that is displayed during printing.

FIG. 18C is a diagram illustrating a display example of a screen with the suggestion for reducing power consumption that is displayed during printing.

FIG. 19A is a diagram illustrating an example of a screen for setting various setting values.

FIG. 19B is a diagram illustrating an example of a screen for setting the various setting values.

FIG. 19C is a diagram illustrating an example of a screen for setting the various setting values.

FIG. 20A is a diagram illustrating an example of a screen including a display “value of power consumption in a predetermined period”.

FIG. 20B is a diagram illustrating an example of a screen including the display “value of power consumption in a predetermined period”.

FIG. 20C is a diagram illustrating an example of a screen including the display “value of power consumption in a predetermined period”.

### DESCRIPTION OF THE EMBODIMENTS

Hereinafter, embodiments of the present disclosure are described with reference to the accompanying drawings. The following embodiments do not limit the present disclosure, and not all the combinations of features described in the embodiments are essential to the solution of the present disclosure. The same components are described with the same reference numerals. The steps in the flowcharts are denoted by reference numerals starting with “S”.

### First Embodiment

### <<Configuration of System>>

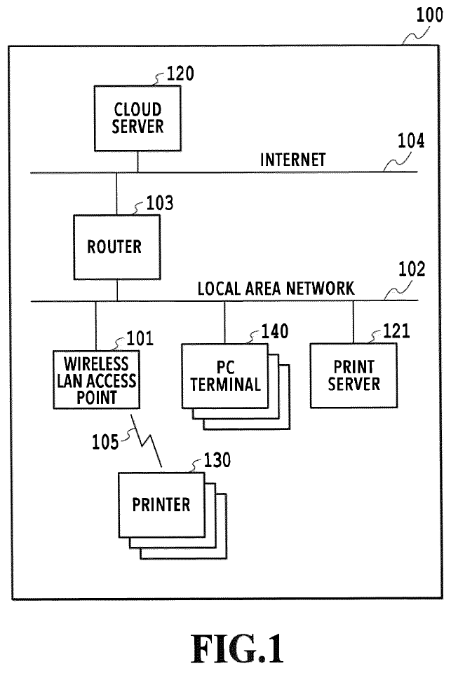

FIG. 1 is a diagram illustrating a configuration of a system 100 according to a first embodiment. This system includes a printer 130, a personal computer (PC) terminal 140, and so on connected through a local area network (LAN) 102. Here, the printer 130 is a mere example, and may be multi-function peripherals including a printing unit and a scanning unit. Also, each printer 130 may be an image processing apparatus including the PC terminal 140. The printer 130 in such an image processing apparatus may be a single-function peripheral or a multi-function peripheral.

The printer 130 wirelessly connects to the LAN 102 through a wireless LAN access point 101 and a wireless LAN 105. Here, the printer 130 and the wireless LAN access point 101 are connected using a router 103 that provides connections in a wireless LAN infrastructure mode. Other apparatuses, such as the PC terminal 140, for example, can be connected to the LAN 102. Also, the LAN 102 is connected to the Internet 104 through the router 103. The printer 130 and other apparatuses are capable of communicating with a cloud server 120 on the Internet 104 through the router 103. Also, a print server 121 is installed in the LAN 102. Terminal apparatuses such as the PC terminal 140 are capable of causing the printer 130 to execute printing through the print server 121, and of checking the status of the printer 130. Note that this configuration only represents one example of the present disclosure, and the present disclosure includes different configurations. For example, while the wireless LAN access point 101 and the router 103 are different apparatuses in FIG. 1, they may be a single router apparatus having an access point function.

### <<Configuration of Printer 130>>

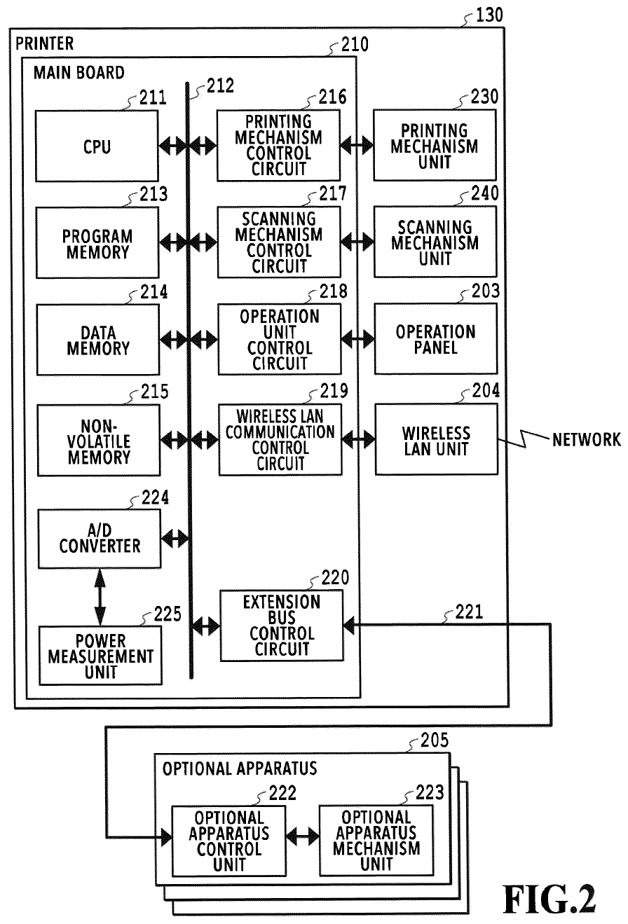

FIG. 2 is a block diagram illustrating a hardware configuration of a control system of the printer 130. The printer 130 includes a main board 210 that comprehensively controls the apparatus, an operation panel 203 that is provided at an outer surface of the apparatus, and various units including a wireless LAN unit 204 and so on. A CPU 211 arranged on the main board 210, which is in the form of a microprocessor, operates in accordance with a control program stored in a program memory 213 connected via an internal bus 212, which is in the form of a read-only memory (ROM), and contents in a data memory 214, which is in the form of a random-access memory (RAM). Additionally, the main board 210 includes a non-volatile memory 215 capable of holding contents therein even after its power supply is stopped. The CPU 211 writes various setting values, data, and the like to the non-volatile memory 215. In a case where the printer 130 is powered off and then supplied with power and start operating, the CPU 211 can continue the operation based on the same setting values and data. The CPU 211 controls a scanning mechanism unit 240 through a scanning mechanism unit control circuit 217 to scan a document and stores the scanned document in the data memory 214 as image data information. Also, the CPU 211 controls a printing mechanism unit 230 through a printing mechanism control circuit 216 to print image data in the data memory 214 on a print sheet. The CPU 211 controls the wireless LAN unit 204 through the wireless LAN communication control circuit 219 to perform wireless LAN communication with other apparatuses. The CPU 211 controls an operation unit control circuit 218 to display the status of the printer 130 on the operation panel 203, display a function selection menu, and receive operations from the user. Specifically, the operation panel 203 is an input device that receives user operations, and also functions as a display device that displays user interface screens (UI screens) and the like. Also, the functions of the CPU 211 include an input function (input unit) to receive inputs into the operation panel 203, and a display control function (display control unit) to control the display of UI screens and the like.

The CPU 211 controls an extension bus control circuit 220 to control optional apparatuses 205 communicatively connected through an extension bus 221. The extension bus 221 is electrically and communicatively connected to optional apparatus control units 222 of the optional apparatuses 205 attached to the printer 130. The CPU 211 of the printer 130 communicates with a specific optional apparatus control unit 222 through the extension bus 221 to obtain the status of the optional apparatus 205 or causes an optional apparatus mechanism unit 223 to operate. Incidentally, the configuration is such that, while plural optional apparatuses 205 can be attached to the printer 130 at a time, the CPU 211 can designate specific optional apparatus 205, communicate with the specific optional apparatus 205, and control the specific optional apparatus 205. A power supply circuit of the main board 210 is provided with a power measurement unit 225 that measures power from the amount of a current flowing through the circuit. The CPU 211 obtains the amount of instantaneous power consumption in the form of a numerical value via an analog-to-digital (A/D) converter 224.

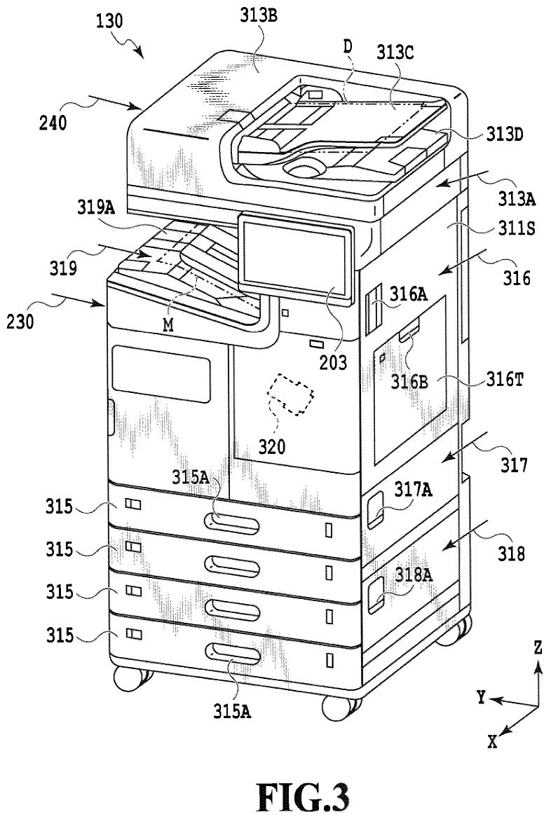

FIG. 3 is a perspective view illustrating an exterior of the printer 130. In FIG. 3, the printer 130 is assumed to be placed on a horizontal installation surface. An upward direction and a downward direction along the Z axis of the printer 130 perpendicular to the installation surface are a +Z direction and a −Z direction, respectively. The two axes perpendicular to the Z axis are the X axis and the Y axis, respectively. Also, an X direction parallel to the X axis includes both an +X direction and an −X direction. The X direction, which is parallel to the X axis, may also be referred to as “width direction X” since it is the width direction of print sheets M. A Y direction parallel to the Y axis includes both a +Y direction and a −Y direction. The Y direction, which is parallel to the Y axis, may also be referred to as “horizontal direction Y.” A Z direction parallel to the Z axis may also be referred to as “vertical direction Z”. As illustrated in FIG. 3, each printer 130 includes a cuboidal printing mechanism unit 230 and a scanning mechanism unit 240 arranged on top of the printing mechanism unit 230. The printing mechanism unit 230 has conveyance paths through which to convey print sheets M.

The scanning mechanism unit 240 includes a scanning unit 313A and an automatic document feeding unit 313B. The automatic document feeding unit 313B feeds a document D placed on a document tray 313C to the scanning unit 313A, and discharges the document D scanned by the scanning unit 313A onto a document discharge tray 313D. Also, in addition to the feed scanning function to scan a conveyed document D, the scanning unit 313A has a flatbed scanning function to scan a document D set on a platen glass which appears in a case where the automatic document feeding unit 313B is opened.

The printer 130 may have the operation panel 203. The operation panel 203 may have a display unit 203A including a touch panel, for example. In other words, the user may be able to give instructions to the printer 130 by performing touch operations on the display unit 203A.

The printer 130 may include cassettes 315 capable of accommodating plural print sheets M. A single cassette 315 may be provided, or plural cassettes 315 (four in FIG. 3) may be stacked. The cassettes 315 are arranged under the printing mechanism unit 230 in a state where each cassette can be attached and detached by sliding it in the X-axis direction using a handle 315A.

As illustrated in FIG. 3, the printing mechanism unit 230 includes plural cover doors 316, 317, and 318 on its side surface 311S. The plural cover doors 316, 317, and 318 have handles 316A, 317A, and 318A for the user to perform opening and closing operations. The first cover door 316 includes a feed tray 316T on which print sheets M can be placed. The feed tray 316T has a handle 316B for the user to perform opening and closing operations.

As illustrated in FIG. 3, the printer 130 has a printing unit 320 that performs printing on print sheets M. The printing unit 320 performs printing on print sheets M fed from the cassettes 315 and print sheets M fed from the feed tray 316T. The printer 130 includes a discharge unit 319 on which to discharge printed print sheets M. The discharge unit 319 has a discharge tray 319A on which to place the print sheets M discharged from the printing mechanism unit 230. The printer 130 may have optional components that can be attached to and detached from the printer 130 (not illustrated in FIG. 3). For example, the discharge unit 319 on which to discharge printed print sheets M may be provided with a shift sorter having the function to sort the print sheets M.

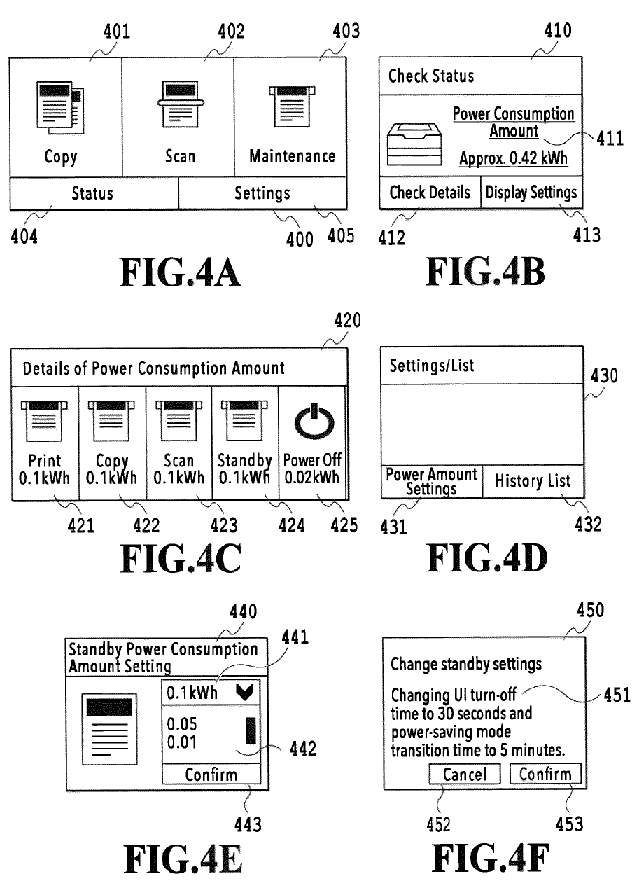

FIGS. 4A to 4F are diagrams illustrating an example of screens displayed on the operation panel 203 of the printer 130. FIG. 4A is a diagram illustrating an example of a home screen 400. The home screen 400 is a screen displayed in a case where the printer 130 is in a standby state, and receives instructions to execute functions from the user. The home screen 400 is provided with a copy button 401, a scan button 402, a maintenance button 403, a status display button 404, and a setting button 405 for selecting functions to execute. Pressing the copy button 401 causes the screen to transition to one for executing a copy function. Pressing the scan button 402 causes the screen to one for executing a scan function. Pressing the maintenance button 403 causes the screen to transition to one for executing a maintenance function, such as adjustment of various settings of the printer 130 or cleaning of the printing mechanism unit 230. Pressing the status display button 404 causes the screen to transition to a status display screen 410 to be described later. Pressing the setting button 405 causes the screen to transition to one for changing various settings (not illustrated).

FIG. 4B is a diagram illustrating an example of the status display screen 410. Pressing the status display button 404 on the home screen 400 displays the status display screen 410. An amount of power consumption 411 indicates a value calculated by a first power aggregation unit 1012 to be described later for a period set in advance (predetermined period). For example, in a case where plural print jobs were executed during the predetermined period, the cumulative amount of power consumed by those print jobs is used to calculate the amount of power consumption 411. Pressing a detail check button 412 displays a power consumption amount detail screen 420 to be described later (see FIG. 4C). Also, pressing a display setting button 413 causes the screen to transition to another one for setting a calculation method of the amount of power consumption for displaying the amount of power consumption.

FIG. 4C is a diagram illustrating an example of the power consumption amount detail screen 420. The power consumption amount detail screen 420 displays the amount of power consumption of the printer 130 on a state-by-state basis. The power consumption detail screen 420 displays the cumulative amount of power consumption of print jobs, the cumulative amount of power consumption of copy jobs, the cumulative amount of power consumption of scan jobs, the cumulative amount of power consumption during standby, and the cumulative amount of power consumption during power-off. Although not illustrated in FIG. 4C, the cumulative amounts of power consumed by other executed jobs may be displayed.

Processes to be performed in response to pressing a print setting button 421, a copy setting button 422, and a scan setting button 423 in FIG. 4C will be described later. Pressing a standby setting button 424 displays a UI screen (see FIG. 4D) displaying a power amount setting button 431 that displays a standby state power amount setting screen illustrated in FIG. 4E and a history list button 432 that displays a list of histories of amounts of power consumption during standby (not illustrated). This UI screen will be referred to as “setting/list display screen”. Pressing the power amount setting button 431 in FIG. 4D displays a standby state power setting screen 430 illustrated in FIG. 4E. Pressing the history list button 432 in FIG. 4D displays a list of histories of amounts of power consumption during standby (not illustrated). Description of this is omitted since the subsequent processing is similar to the processing for displaying a list of histories of jobs of each type to be described later. The processing in a case of pressing a power off setting button 425 is similar to the processing in the case of pressing the standby setting button 424, and description thereof is therefore omitted.

Processing in a case of pressing the print setting button 421 in FIG. 4C, which displays the cumulative amount of power consumption of print jobs, will now be specifically described. Pressing the print setting button 421 in FIG. 4C displays a setting/list display screen (see FIG. 4D) displaying a power amount setting button 431 that displays a printing state power amount setting screen (not illustrated) and a history list button 432 that displays a list of histories of print jobs.

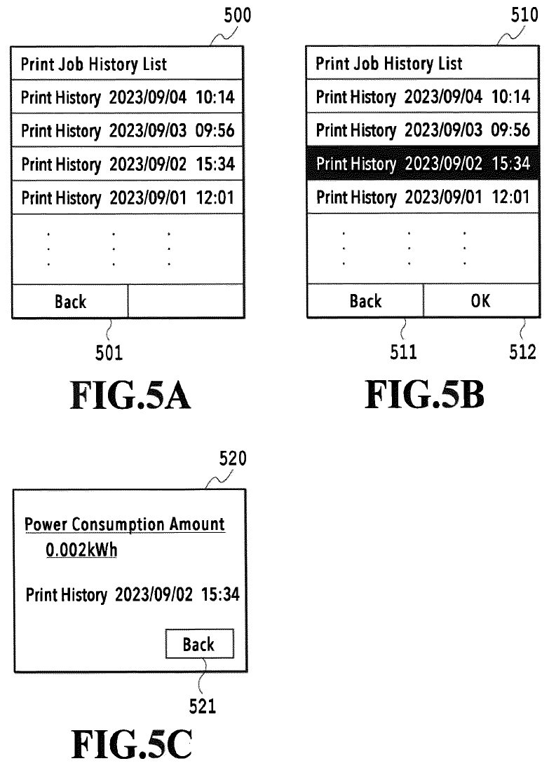

Pressing the power amount setting button 431 in FIG. 4D displays the printing state power setting screen (not illustrated). Also, pressing the history list button 432 displays a print job history list screen 500 illustrated in FIG. 5A. Selecting a desired print job in FIG. 5A through a user operation displays only the selected print job with its black and white colors inverted, as illustrated in FIG. 5B. Pressing a back button 501 in FIG. 5A brings the screen back to the setting/list display screen in FIG. 4D. Pressing an OK button 512 in FIG. 5B displays the amount of consumed power of the selected print job, as illustrated in FIG. 5C. This allows the user to know the amount of consumed power of the print job selected by the user operation. Pressing a back button 511 in FIG. 5B brings the UI screen back to the screen in FIG. 5A. Pressing a back button 521 on the screen in FIG. 5C brings the UI screen back to the screen in FIG. 5A. Incidentally, while the amount of power consumption is displayed on a separate screen in the above, each amount of power consumption may be displayed on the list display screen in FIG. 5A in association with the corresponding history, e.g., at its right end.

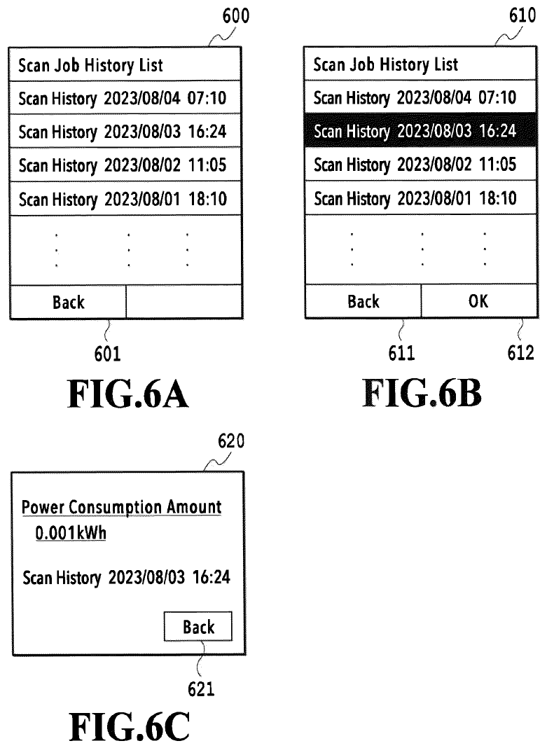

Performing similar screen operations allows the user to know the amount of power consumption of an executed scan job or an executed copy job. Processing in a case of pressing the scan setting button 423 in FIG. 4C, which displays the cumulative amount of power consumption of scan jobs, will now be described. Pressing the scan setting button 423 displays a setting/list display screen (see FIG. 4D) displaying a power amount setting button 431 that displays a scanning state power amount setting screen (not illustrated) and a history list button 432 that displays a list of histories of scan jobs. Pressing the history list button 432 on the setting/list display screen in FIG. 4D displays a scan job history list screen 600 illustrated in FIG. 6A. Selecting a desired scan job in FIG. 6A through a user operation displays only the selected scan job with its black and white colors inverted, as illustrated in FIG. 6B. Pressing an OK button 612 in FIG. 6B displays the amount of power consumption of the selected scan job, as illustrated in FIG. 6C. This allows the user to know the amount of power consumption of the scan job selected by the user operation. Pressing a back button 611 in FIG. 6B brings the UI screen back to the screen in FIG. 6A. Pressing a back button 621 on the screen in FIG. 6C brings the UI screen back to the screen in FIG. 6A. Incidentally, while the amount of power consumption is displayed on a separate screen in the above, each amount of power consumption may be displayed on the list display screen in FIG. 6A in association with the corresponding history, e.g., at its right end.

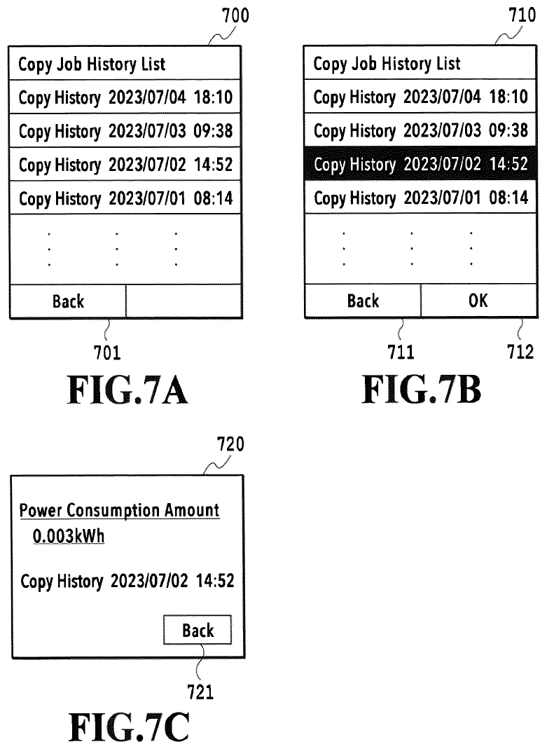

Processing in a case of pressing the copy setting button 422 in FIG. 4C, which displays the cumulative amount of power consumption of copy jobs, will now be described. Pressing the copy setting button 422 displays a setting/list display screen (see FIG. 4D) displaying a power amount setting button 431 that displays a copying state power amount setting screen (not illustrated) and a history list button 432 that displays a list of histories of copy jobs. Pressing the history list button 432 on the setting/list display screen in FIG. 4D displays a copy job history list screen 700 illustrated in FIG. 7A. Selecting a desired copy job in FIG. 7A through a user operation displays only the selected copy job with its black and white colors inverted, as illustrated in FIG. 7B. Pressing an OK button 712 in FIG. 7B displays the amount of power consumption of the selected copy job, as illustrated in FIG. 7C. This allows the user to know the amount of power consumption of the copy job selected by the user operation. Pressing a back button 711 in FIG. 7B brings the UI screen back to the screen in FIG. 7A. Pressing a back button 721 on the screen in FIG. 7C brings the UI screen back to the screen in FIG. 7A. Incidentally, while the amount of power consumption is displayed on a separate screen in the above, each amount of power consumption may be displayed on the list display screen in FIG. 7A in association with the corresponding history, e.g., at its right end.

FIG. 4E is a diagram illustrating an example of a standby state power amount setting screen 440. On the standby state power amount setting screen 440, a power consumption display 441 indicates the current value of power consumption. Also, power consumption value setting options 442 indicate a range of values within which the value of power consumption is changeable, and a value of power consumption desired to be set can be selected from among them. Pressing a confirm button 443 in a state where the value of power consumption desired to be set is selected displays a standby state power amount setting confirmation screen 450 illustrated in FIG. 4F.

FIG. 4F is a diagram illustrating an example of the standby state power amount setting confirmation screen 450. The standby state power amount setting confirmation screen 450 notifies, in a region 451, of settings to be changed to apply the value of power consumption determined by the press on the confirm button 433 described above. The user checks this notification. In a case where the user determines that these settings are acceptable, the user presses a confirm button 453 to apply the settings. On the other hand, in a case where the user does not desire to apply these settings, the user presses a cancel button 452 to transition from the current screen to another without applying the settings.

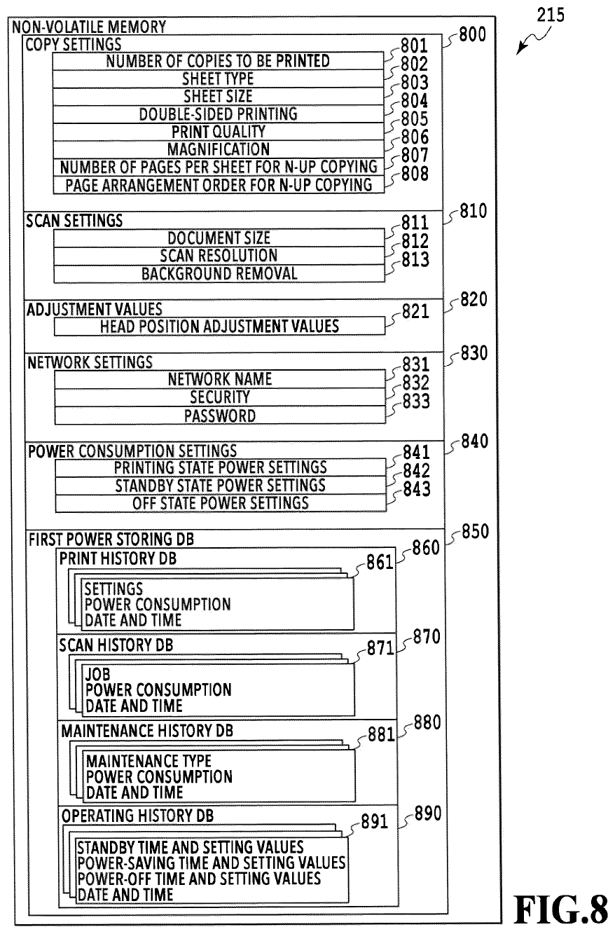

FIG. 8 is a diagram illustrating a data structure stored in the non-volatile memory 215. Data in the non-volatile memory 215 are divided and stored in regions for copy settings 800, scan settings 810, adjustment values 820, network settings 830, power consumption settings 840, a first power storing database (DB) 850, and so on. In addition to these, various data such as control parameters, apparatus state variables, and so on are stored in the non-volatile memory 215, but only data relevant to the present embodiment are selectively illustrated in FIG. 8.

The copy settings 800 represent a region storing setting values related to copy operations. The copy settings 800 include the number of copies to be printed 801, a sheet type 802, a sheet size 803, a double-sided printing setting 804, a print quality 805, and so on for copying. Also, the copy settings 800 include a copy magnification 806 for enlarged or reduced copying, the number of pages per sheet 807 for N-up copying, a page arrangement order 808, and so on. The scan settings 810 represent a region storing setting values related to scan operations. The scan settings 810 include a scan target document size 811, a scan resolution 812, a background removal setting 813, and so on. The adjustment values 820 represent a region storing setting values related to basic operation of the printer 130. The adjustment values 820 include head position adjustment values 821 for color alignment and bidirectional misalignment adjustment of the inkjet print head, and so on. The network settings 830 represent a region storing setting values necessary for establishing a network connection. The network settings 830 include a network name 831 of the access point to be connected, connection security settings 832, and a password 833 for connecting to the access point. The power consumption settings 840 represent a region storing setting values that influence the power consumption. The power consumption settings 840 include printing state power settings 841 that influence the power consumption during printing, standby state power settings 842 that influence the power consumption during standby, power off state power settings 843 that influence the power consumption during power-off, and so on.

The first power storing DB 850 is a database region in which information on power consumed by the apparatus'operations is stored in the form of histories. The first power storing DB 850 includes a print history DB 860, a scan history DB 870, a maintenance history DB 880, and an operation history DB 890. Note that these DBs may be configured as database management systems independent of one another or configured to be managed by a single database management system by attaching type information to each database record. The print history DB 860 is a database storing print history records 861 in each of which information on the power consumed by an individual print operation is stored. Each print history record 861 stores the setting values of the executed print job, the power consumed by executing the job, and information on the date and time of execution. The scan history DB 870 is a database storing scan history records 871 in each of which information on the power consumed by an individual scan operation is stored. Each scan log record 871 stores the setting values of the executed scan job, the power consumed by executing the job, and information on the date and time of execution. The maintenance history DB 880 is a database storing maintenance history records 881 in each of which information on the power consumed by an individual maintenance operation is stored. Examples of the maintenance operation include a cleaning operation for maintaining the inkjet print head in good condition, a head position adjustment operation, and so on. Each maintenance history record 881 stores the type and setting values of the executed maintenance operation, the power consumed by the maintenance operation, and information on the date and time of execution. The operating history DB 890 is a database storing the operating history records 891 in each of which information on the power consumed during a period that passed in a state such as the standby state or a power-off state without any of the operations listed above is stored. Each operating history record 891 stores information on the type of the operating state, such as the standby state or the power-off state, setting values corresponding to the operating state, the length of time that passed in the in-operation state, information on the date and time, and so on.

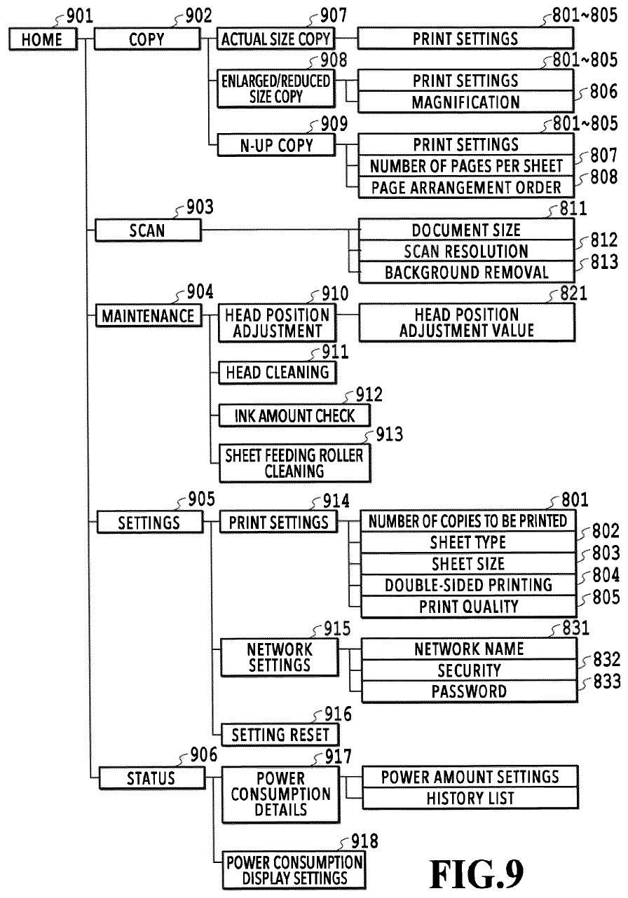

FIG. 9 is a diagram illustrating a menu configuration and setting items on the operation panel 203 of the printer 130. The menu configuration is a tree structure with the home screen 400 is the starting point. In a case where a button on the menu configuration is selected and pressed, the screen transitions to a screen on the underlying layer. On a screen at the lowermost layer, items to be set are displayed. For example, the home screen 400 in FIG. 4A corresponds to home 901 in the menu configuration, and buttons corresponding to menu items of copy 902, scan 903, and maintenance 904 are arranged. Also, the function buttons at the bottom left and right of the screen in FIG. 4A correspond to menu items of status 906 and settings 905, respectively.

### <<Software Processing Blocks of Printer 130>>

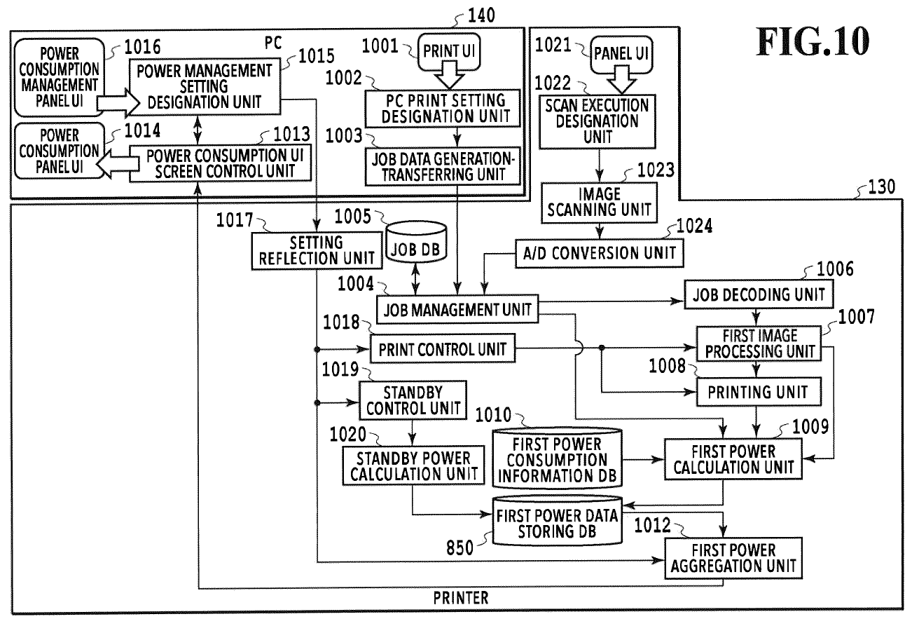

FIG. 10 is a diagram describing software processing blocks for processing by the CPU 211 of the printer 130 in a case of executing printing and scanning. In the print processing in FIG. 10, the user launches a printing application using the PC 140 and issues an instruction to execute printing for the print job on a print UI 1001 of the application. The printing execution instruction is issued by configuring print settings and pressing a printing execution button on the application, and a PC print setting designation unit 1002 applies the settings to the job data generation based on the operation on the print UI 1001.

A job data generation-transfer unit 1003 generates job data in accordance with the printing execution instruction. The job data is converted into a transfer format by which information can be communicated between the PC 140 and the printer 130, and the data includes print settings and image data for printing.

A job management unit 1004 receives the job data within the printer 130, stores the job data in a job DB 1005, and reads the job data thus stored. A job decoding unit 1006 issues an instruction to read the job data stored by the job management unit 1004 and decodes the obtained job data. At this time, the job management unit 1004 can transmit the job data received from the PC 140 directly to the job decoding unit 1006 without passing it through the job DB 1005. The job decoding unit 1006 decodes image data to be printed from the job data and rasterizes it into a bitmap format (a format in which pixel values are continuously written along each direction of the image, instead of a format in which the image is compressed). The job decoding unit 1006 loads the print settings in the job data during the decoding and applies the loaded setting information to a control block responsible for print processing within the printer 130. Note that a different software block may apply the setting information.

A first image processing unit 1007 performs image processing for printing on the bitmap image data, which is the result of the decoding. The contents of the image processing include a process of converting the format of the input color space into ink colors for printing, a process of converting multivalued information of the ink colors into expanded dot patterns, and so on. The contents of the image processing are not limited to these, and processes that imparts additional values, such as a process for enriching the tonality of colors within the printer's color reproduction range and a process for increasing saturation, may be executed. The contents of the processing by the first image processing unit 1007 are determined based on the print settings. A printing unit 1008 controls the printing mechanism unit 230 through the printing mechanism control circuit 216 to print the image data processed by the first image processing unit 1007 on a print sheet. Print processing is executed by the above software blocks.

A first power calculation unit 1009 calculates (obtains) the amount of power consumption of the input job. Here, while an example of calculating the amount of power consumption for the printing of the job data in the print job will be described, the amount of power consumption of the scan job can be calculated in a similar manner as well.

In FIG. 10, as an example, the first power calculation unit 1009 calculates the amount of power consumption based on information from the job management unit 1004, the first image processing unit 1007, and the printing unit 1008. The first power calculation unit 1009 obtains the information of the print settings from the job management unit 1004. A first power consumption information DB 1010 stores fixed power values and power calculation variables that are determined for respective sets of print settings. The first power calculation unit 1009 reads out information matching the print settings from the first power consumption information DB 1010. A “fixed power value” represents power that is included regardless of the contents of the job data in the print settings of interest, and corresponds to, for example, power that is required for the mechanical control for conveying the print sheet or the like. In a case where the job data includes plural pieces of image data, the fixed power value may be calculated based on information such as the number of sheets to be printed, the area of the sheet or sheets to be subjected to the printing, and the like.

A “power calculation variable” represents basic information on power that is included according to the contents of the job data, and corresponds to, for example, power that is required for the ejection of the ink of each color or the like. The first power calculation unit 1009 obtains the ink ejection density (printing density) or the number of dots to be ejected (ejection dot count) of the image data obtained from the first image processing unit 1007 or the printing unit 1008, and combines this with the power calculation variable to calculate a power value. Obtaining the number of dots to be ejected with the first image processing unit 1007, rather than the ejection density, is effective for calculating accurate power. As compared to the number of dots to be ejected that can be obtained with the first image processing unit 1007, the number of dots to be ejected that can be obtained with the printing unit 1008 can be used to calculate more accurate power in which ejection control that is performed for the print head, such as continuous ejection control and misfiring control, can be reflected. Thereby, it is possible to calculate the amount of power consumption of the print job, which varies according to the contents of its processing, based on the power value obtained by combining the fixed power value, the ink ejection density (printing density) or the number of dots to be ejected (ejection dot count), and the power calculation variable. By using the power that varies according to the contents of the job data as described above in the calculation of the amount of power consumption, accurate information on the amount of power consumption of the print job can be presented to the user on the operation panel 203 of the printer 130. Alternatively, the information on the amount of power consumption of the print job may be displayed on a power consumption panel UI 1014 of the PC 140. In this way, the user can refer to this information and utilize it for power management.

The first power storing DB 850 stores the result of the power calculation by the first power calculation unit 1009. The power calculation result can be stored in association with the date and time of the printing of the job data and its calculated power value. The first power aggregation unit 1012 obtains the information of the power calculation result from the first power storing DB 850. The user can confirm the status of the power consumption on the power consumption panel UI 1014 of the PC 140.

A power consumption UI screen control unit 1013 obtains the power calculation result from the first power aggregation unit 1012 and displays it on the power consumption panel UI 1014 in response to receiving a display request from the user through the power consumption panel UI 1014. The first power aggregation unit 1012 aggregates the results of power calculations performed during a predetermined period based on a power aggregation period that was set in advance by the user or has been set as an initial setting in the printing application. In the aggregation, the total amount of power consumption, which is the sum of the calculated power values, can be calculated as well. Also, based on the total amount of power consumption and the predetermined period, an average amount of power for the predetermined period can be calculated as well. Further, the cumulative amount of power consumption can be calculated for each job type and displayed on the power consumption panel UI 1014 or the operation panel 203 of the printer 130. The amount of power consumption of the job data which consumed the largest or smallest amount of power among the pieces of job data that were made during the predetermined period can be calculated. The first power aggregation unit 1012 or the power consumption UI screen control unit 1013 may execute a calculation process for displaying such an amount of power consumption.

On a power consumption management panel UI 1016, the user can designate a display method of the power consumption, an aggregation method of the power consumption, the control method for reducing the power consumption of the printer 130, and so on. A power management setting designation unit 1015 notifies the printer 130 of information on the display method, the aggregation method, the control method, and the like in response to receiving a request from the user through the power consumption management panel UI 1016. The various amounts of power consumption described above may be displayed on the operation panel 203 of the printer 130.

A setting reflection unit 1017 obtains information from the PC 140 and reflects the obtained information to software blocks. For example, the setting reflection unit 1017 changes the image processing method and the printing method for a set of print settings managed by a print control unit 1018. The setting reflection unit 1017 reflects the changed information to the first image processing unit 1007 and the printing unit 1008 in a case of printing job data.

The above has described a series of operations for calculating power required for printing of job data. In the present embodiment, a configuration capable of calculating other power is employed. A standby power calculation unit 1020 calculates power values required for operations other than printing and stores them to the first power storing DB 850. Examples of the power values required for operations other than printing include power required for ejecting the inks in regular maintenance, power required for driving the print head during the maintenance, and the like. A standby control unit 1019 receives information from the setting reflection unit 1017. Specifically, the standby control unit 1019 instructs the standby power calculation unit 1020 with information indicating whether to store or not to store the power required during the standby state as an operation other than printing.

The setting reflection unit 1017 transmits the information to the first power aggregation unit 1012 as well. Based on the transmitted information, the first power aggregation unit 1012 reflects the aggregation period and the aggregation method. The first power aggregation unit 1012 is capable of reflecting information indicating whether to aggregate or not to aggregate the power required during the standby state.

The calculation of the power required during printing and during standby has been described above. In the present embodiment, power for executing the scanning can be calculated as well. A panel UI 1021 installed in the printer 130 receives scan settings for a document placed on a scanner bed by the user and an instruction to execute the scanning. A scan execution designation unit 1022 obtains instruction information from the panel UI 1021 and issues an instruction to execute the scanning.

An image scanning unit 1023 turns on its light emitting diode (LED) and scans the document in accordance with the scan execution instruction. During the scanning of the document, the image scanning unit 1023 executes control for receiving the reflection of light with a sensor, control for scanning the sensor in a designated direction of the document, and the like. An A/D conversion unit 1024 converts the analog information received by the image scanning unit 1023 with its sensor into digital information. Processes such as a process of correcting blur resulting from the scanning by the scanner, a process of removing the paper white portion, a color conversion process corresponding to the color gamut for display, and the like, are performed to the digital information.

The amount of power consumption can be calculated also for such scan processing. As with the print jobs, the first power consumption information DB 1010 holds fixed power values for the scan jobs. The contents of the processes such as the blur correction process, the paper white portion removal process, the color conversion process corresponding to the color gamut for display, and the like vary depending on the scan job to be executed. The first power calculation unit 1009 calculates the amount of power consumption according to the settings for the executed scan. The amount of variation in power that occurs in a case of changing image processing control for the image processing during the scan according to the content information of the scanning result can also be reflected to the first power calculation unit 1009. Specifically, as with the print jobs, the amount of power consumption of the scan job, which varies according to the contents of its processing, can be calculated based on a fixed power value and a power calculation variable which varies by the scan job. The calculated amount of power consumption of the scan job is stored in the first power storing DB 850. Also, as with the print jobs, information on the amount of power consumption of the scan job is displayed on the operation panel 203 of the printer 130 or the power consumption panel UI 1014 of the PC 140.

As described above, the configuration illustrated in FIG. 10 allows for power calculation, display of the amount of power consumption r, power control, and the like. The configuration in FIG. 10 is an example, and the method and the block configuration for executing the power calculation, the display of the amount of power consumption, and the power control are not limited to this.

Although use cases for copying, faxing, and the like are not illustrated, it is possible to perform power calculation, display of the amount of power consumption, and power control in such use cases. Note that processes illustrated in FIG. 10 are assumed to be executed by the CPU 211, but some or all of the processing can be executed by a hardware circuit, such as an application-specific integrated circuit (ASIC) or a field programmable gate array (FPGA). Executing some or all of the processes with a hardware circuit allows for high-speed processing. Also, while the display of the power aggregation result, control instructions, and so on are designated from the PC 140 in FIG. 10, the present embodiment is not limited to this. For example, the power aggregation result may be displayed on the operation panel 203 of the printer 130.

### <<Amount of Power Consumption of Printer 130>>

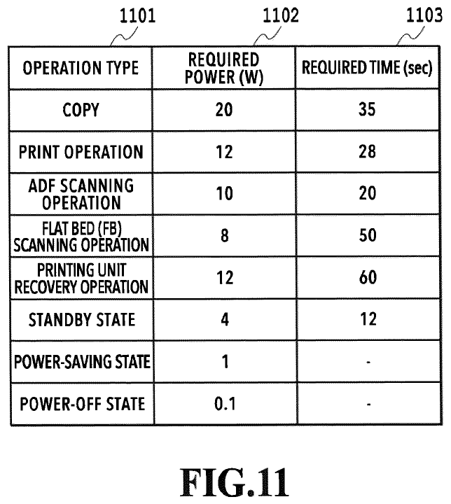

FIG. 11 is a table indicating the amount of power consumption of the printer 130 that varies according to its operating status. Operation type 1101 represents a list of types of operations by the printer 130. “Copy” is an operation of scanning a sheet with the scanner in the main body of the printer 130 and printing the scanned image data. “Print Operation” is an operation of receiving print data from the PC, a smartphone, or the like and performing printing based on the received data. “ADF (Auto Document Feeder) Scanning Operation” is to scan a document with an ADF and convert the scanned image data into electronic data. “FB (Flat Bed) Scanning Operation” is to scan a document with an FB and convert the scanned image data into electronic data. “Printing Unit Recovery Operation” is a printing performance recovery operation that is performed while a print operation is performed in order to prevent clogging of the print head and for other similar purposes. “Standby State” is a state where the power supply is turned on but no operation is being performed. “Power-saving State” is a state where the power supply is turned on but the main body of the printer 130 has transitioned to a sleep state, stopping some of its functions. “Power-off State” refers to a state where the power supply of the printer 130 is turned off.

Required power 1102 and required time 1103 represent an example of estimated values of power values that will be required for the operations of the print job, the scan job, the copy job, and so on under a predetermined condition and estimated values of the times that will be required for the operations, respectively. The powersaving state and the power-off state will each be maintained until the user performs an operation. For this reason, no required time is specified in this table. The predetermined condition in the example of FIG. 11 represents an estimated value for a job that processes 10 reference images which are A4, one-sided, and full-color images. Using the data in FIG. 11, the amount of power consumption in a case of executing a job that processes 1000 reference images which are A4, one-sided, and full-color images will be as follows. The print job will require 0.009 (kWh), the scan job will require 0.006 (kWh), and the copy job will require 0.019 (kWh). Also, the amount of power consumption in a case of executing a job that processes 5000 reference images which are A4, one-sided, and full-color images will be as follows. The print job will require 0.047 (kWh), the scan job will require 0.027 (kWh), and the copy job will require 0.098 (kWh).

The printer 130 has the power consumption amount table illustrated in FIG. 11 for each of various conditions, and is capable of calculating the amount of power consumption of a job based on the power consumption amount table matching an executed job. Also, by calculating the sum of the amounts of power consumption for each job type, it is possible to calculate the cumulative amount of power consumption during a predetermined period for each job type.

In the above, the description has been given based on an example with a job that processes reference images. This may be considered the fixed power value described above. Images of various printing densities are printed by the print jobs. The printer 130 in the present embodiment obtains printing density or dot count data on a per-print job basis. The amount of power consumption that varies by the job may be considered the power calculation variable described above. By calculating the amount of power consumption of the print job using the power value under the predetermined condition described above (fixed power value) and the power calculation variable corresponding to the obtained printing density or dot count data, the amount of power consumption of the print job can be obtained more accurately. Similarly, various images are scanned by the scan jobs. The printer 130 in the present embodiment obtains the contents of the blur correction process, the paper white portion removal process, and the color conversion process corresponding to the color gamut for display for each scan job. As with the print jobs, processing of the reference image may be considered the fixed power value, and the amount of power consumption of processing that varies by the job may be considered the power calculation variable. By calculating the amount of power consumption of the scan job using the power value under the predetermined condition described above (fixed power value) and the power calculation variable corresponding to the contents of the processes described above, the amount of power consumption of the scan job can be obtained more accurately. While details are not described, the amount of power consumption of the copy job can be accurately obtained by using a similar method.

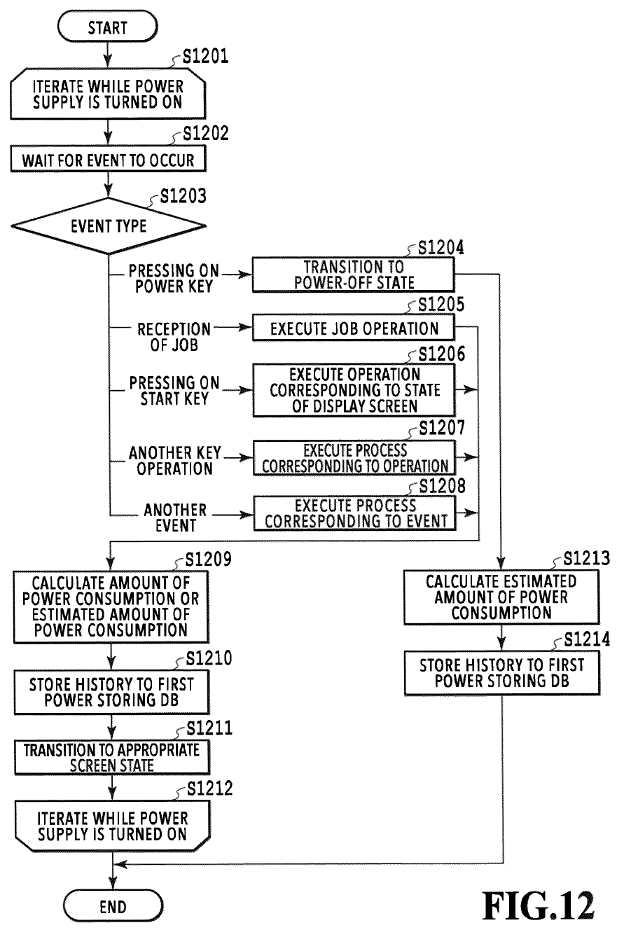

FIG. 12 is a flowchart illustrating contents of processing by the CPU 211 of the printer 130. The CPU 211 of the printer 130 executes the processing in FIG. 12 in a case where the power supply of the printer 130 gets turned on, and iterates the processes of S1201 to S1212 in FIG. 12 while the power supply of the printer 130 is turned on. In S1202, which is the first step in an iteration loop, the CPU 211 of the printer 130 waits for an event to occur. In a case where it is detected in S1202 that an event has occurred, the processing proceeds to S1203.

In S1203, the CPU 211 performs the processing corresponding to the type of the event that occurred. In a case where the event that occurred was a press on a power key provided on the operation panel 203 in S1203, the processing proceeds to S1204, in which the printer 130 transitions to the power-off state from the power-on state. As a result, the processing exits the iteration loop, followed by performing the processes of S1213 and S1214 to be described later and entering a dormant state until the power supply is turned on next time. In a case where the event that occurred was reception of an instruction to execute a job, such as a print job or a scan job, from an external apparatus in S1203, the processing proceeds to S1205, in which an operation corresponding to the contents of the received job is executed.

In a case where the event that occurred was a press on a start key provided on the operation panel 203 in S1203, the processing proceeds to S1206, in which an operation based on settings displayed on the display screen is executed. Here, assume that the scan job or the copy job is executed. In a case where the event that occurred was an operation on the operation panel 203 in S1203, the processing proceeds to S1207, in which the processing corresponding to the panel operation is executed. For example, for an operation on a touch panel, the appropriate processing corresponding the touched coordinates is performed. In a case where a touch on a button arranged on the screen was detected, the screen transitions to an appropriate screen corresponding to the pressed button or an appropriate process corresponding to the pressed button is executed, for example. In a case where the event that occurred was another event in S1203, the processing proceeds to S1208, in which the processing corresponding to the event that occurred is executed. After the processing corresponding to the event that occurred is completed in the processing of one of S1205 to S1208, the processing proceeds to S1209.

In S1209, the CPU 211 calculates the amount of power consumption of the received job or the operation executed in S1206, and calculates an estimated amount of power consumption corresponding to the event that occurred. In S1210, the CPU 211 stores the calculated amount of power consumption and estimated amount of power consumption to the first power storing DB 850 in the non-volatile memory 215 as history information. In S1211, the CPU 211 determines the display screen to which to transition based on the combination of the screen currently displayed on the operation panel 203 and the received job or the event that occurred, and the display screen transitions to the determined screen.

In S1213, the CPU 211 calculates an estimated amount of power consumption corresponding to the event that occurred. In S1214, the CPU 211 stores the estimated amount of power consumption to the first power storing DB 850 in the nonvolatile memory 215 as history information, and terminates the processing in the flowchart illustrated in FIG. 12. Using the history information in the first power storing DB 850, the CPU 211 can calculate the cumulative amount of power consumption of the print jobs, the cumulative amount of power consumption of the copy jobs, the cumulative amount of power consumption of the scan jobs, the cumulative amount of power consumption during standby, and the cumulative amount of power consumption during power-off in a predetermined period. Further, the CPU 211 can display information on the calculated cumulative amounts of power consumption, the calculated amount of power consumption of each job, and the like on the operation panel 203. Also, the information on the cumulative amounts of power consumption and the amounts of power consumption described above may be displayed on the power consumption panel of the PC 140.

According to the present embodiment, various amounts of power consumption can be calculated. Thereby, information on the amounts of power consumed by the image processing apparatus can be presented. Further, the user can confirm the displayed amounts of power consumption and change various settings through the operation panel of the printer, resulting in reducing the amounts of power consumption.

### Second Embodiment

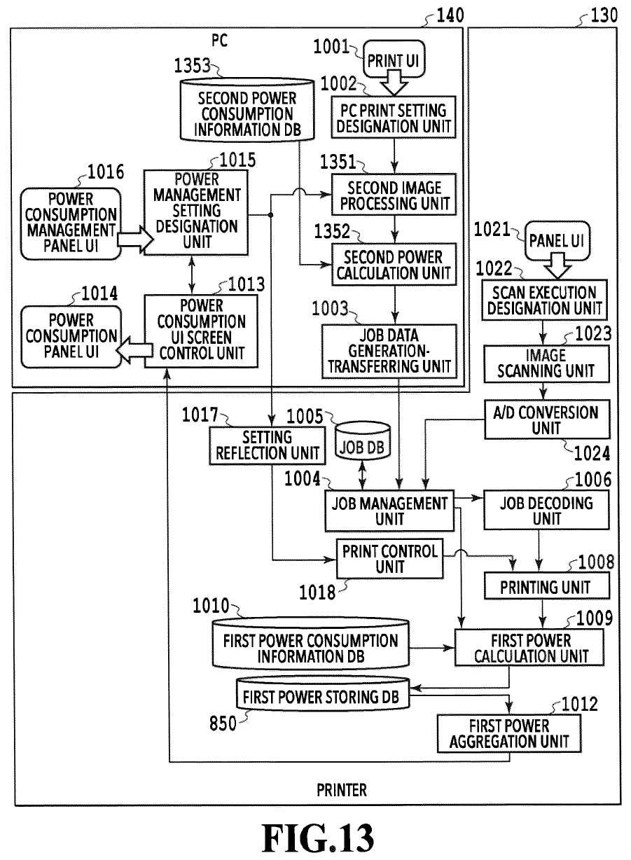

FIG. 13 describes software processing blocks for processing by the CPU 211 of the printer 130 in a second embodiment in a case of executing the print job and the scan job. Description of parts that are similar to those in FIG. 10 will be omitted, and the configuration of the system 100 required for the PC 140 to calculate the amount of power consumption, which is a characteristic feature of the second embodiment, will be described.

A second image processing unit 1351 executes image processing on an image to be printed in accordance with an instruction to execute the print job. The contents of the image processing include the processing of converting the format of the input color space into ink colors for printing, the processing of converting multivalued information of the ink colors into expanded dot patterns, and so on. The contents of the image processing are not limited to these, and the processing that imparts additional values, such as the processing for enriching the tonality of colors within the printer's color reproduction range and the processing for increasing saturation, may be executed. The contents of the processing by the second image processing unit 1351 are determined based on print settings designated by the user on the print UI 1001.

A second power calculation unit 1352 calculates the amount of power consumption for the printing of the job data. In the present embodiment, the second power calculation unit 1352 obtains information on the print settings from the PC print setting designation unit 1002. The second power calculation unit 1352 obtains information matching the print settings from a second power consumption information DB 1353 and the ejection density (printing density) or the number of dots to be ejected (ejection dot count) from the second image processing unit 1351, and calculates the amount of power consumption in a similar manner to that described with reference to FIG. 10. In FIG. 13, the PC 140 executes the image processing. Employing this configuration also allows the PC 140 to use the power which varies according to the contents of the job data, resulting in calculating the amount of power consumption. That is, the PC 140 calculates the amount of power consumption of the print job.

The job data generation-transfer unit 1003 converts information including the image data obtained as a result of the processing by the second image processing unit 1351 into a transferring format. In doing so, the job data generation transfer unit 1003 can include the amount of power consumption calculated by the second power calculation unit 1352 in the transferring format. Note that the method of transferring the amount of power consumption to the printer 130 is not limited to this, and the transferring format or the transferring method other than that for the image data may be used to transfer the amount of power consumption. The transferred amount of power consumption is stored to the job management unit 1004.

The first power aggregation unit 1012 aggregates the amounts of power consumption in a similar manner to that described with reference to FIG. 10. At this time, the job management unit 1004 obtains the amounts of power consumption held in the job DB 1005. Thereby, the amount of power consumed by the image processing executed by the PC 140 can be added as an amount of power consumption to be aggregated by the first power aggregation unit 1012.

The second image processing unit 1351 of the PC 140 can be notified of a control method designated by the power management setting designation unit 1015, and this control method can be changed based on a user instruction. For example, in a system for which the time of transferring from the PC 140 to the printer 130 is an issue, the PC 140 may need to complete in advance the image processing that executes conversion into a quantization format capable of representing data with a small number of bits, in order to minimize the transferring size. According to the present embodiment, employing the software block configuration illustrated in FIG. 13 allows even a system as above to calculate the amount of power consumption.

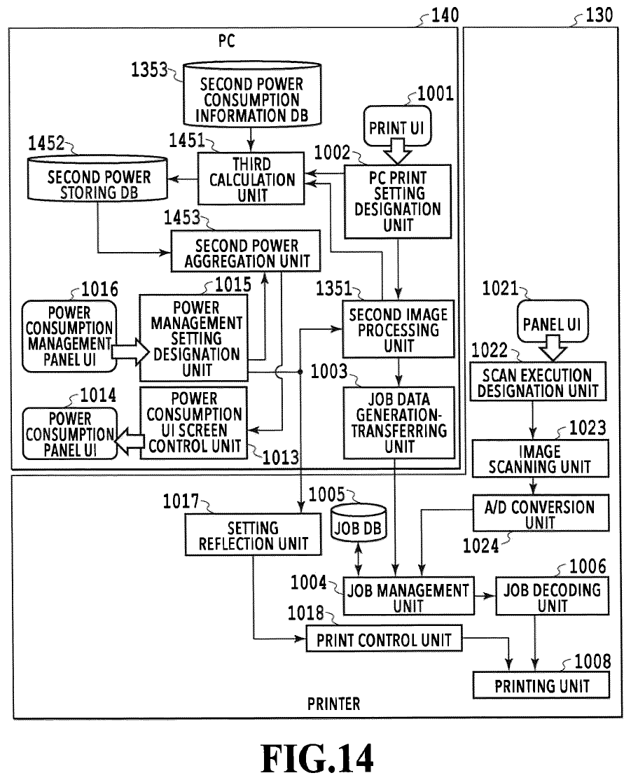

The software blocks illustrated in FIG. 13 are an example, and another configuration as illustrated in FIG. 14, for example, may be employed. A third power calculation unit 1451 of the PC 140 calculates the amount of power consumption for printing of job data. The third power calculation unit 1451 obtains information on the print settings from the PC print setting designation unit 1002. The third power calculation unit 1451 obtains information matching the print settings from the second power consumption information DB 1353 and the ejection density or the number of dots to be ejected from the second image processing unit 1351, and calculates the amount of power consumption in a similar manner to that described with reference to FIG. 10. In FIG. 14, the PC 140 executes the image processing. In this way, the power which varies according to the contents of the job data can also be used to calculate the amount of power consumption. That is, the PC 140 calculates the amount of power consumption of the print job, whose amount of power consumption varies according to the contents of its processing.

A second power storing DB 1452 stores the result of the power calculation by the third power calculation unit 1451. The power calculation result is stored in association with the date and time of the printing of the job data and its calculated power value. A second power aggregation unit 1453 obtains the information of the power calculation result from the second power storing DB 1452. A method of displaying the amount of power consumption, a method of aggregating the amounts of power consumption, and a control method for reducing the amount of power consumption of the printer 130 are designated through the power management setting designation unit 1015 in a similar manner to that described with reference to FIG. 10. As described above, the configuration illustrated in FIG. 14 allows for calculation and display or control of the amount of power consumption. In the configuration illustrated in FIG. 14, the PC 140 executes the calculation of the amount of power consumption and the aggregation processing of the amount of power consumption.

The configuration for calculating the amount of power consumption, displaying the amount of power consumption, controlling the amount of power consumption, and the like is not limited to this. The above-described configuration can also be used to execute the processing such as calculation of the amount of power consumption for copying, faxing, and the like, which are not illustrated. Note that some or all of the processing described to be performed by the CPU 211 of the printer 130 can be executed by a hardware circuit, such as an ASIC or an FPGA. Executing some or all of the processing with the hardware circuit allows for high-speed processing.

Also, in the present embodiment, it is possible to execute calculation of the amount of power consumption that is not related to printing and is not illustrated in FIG. 14. Information on the values of power consumption required for actions other than printing may be stored in the second power consumption information DB 1353 in advance and, in a case where an action such as maintenance or the like occurs, the corresponding information of the value of power consumption may be stored to the second power storing DB 1452. The PC 140 may determine whether to execute maintenance or the CPU 211 of the printer 130 may determine it. In a case where the printer 130 determines whether to execute maintenance, the printer 130 transmits the history of execution of the maintenance, which is not illustrated in FIG. 14, to the PC 140 as appropriate. Calculation of the amount of power consumption of the scan job, which is not illustrated in FIG. 14, is similar. The amount of power consumption of the scan job, whose amount of power consumption varies according to the contents of its processing, is calculated by the printer 130, and the calculated amount of power consumption of the scan job is transmitted to the PC 140 from the printer 130.

Also, while the display of the power aggregation result, the control instructions of the power consumption, and so on are designated from the PC 140 in FIG. 14, the present embodiment is not limited to this. For example, the amount of power consumption and the power aggregation result may be displayed on the operation panel 203 of the printer 130.

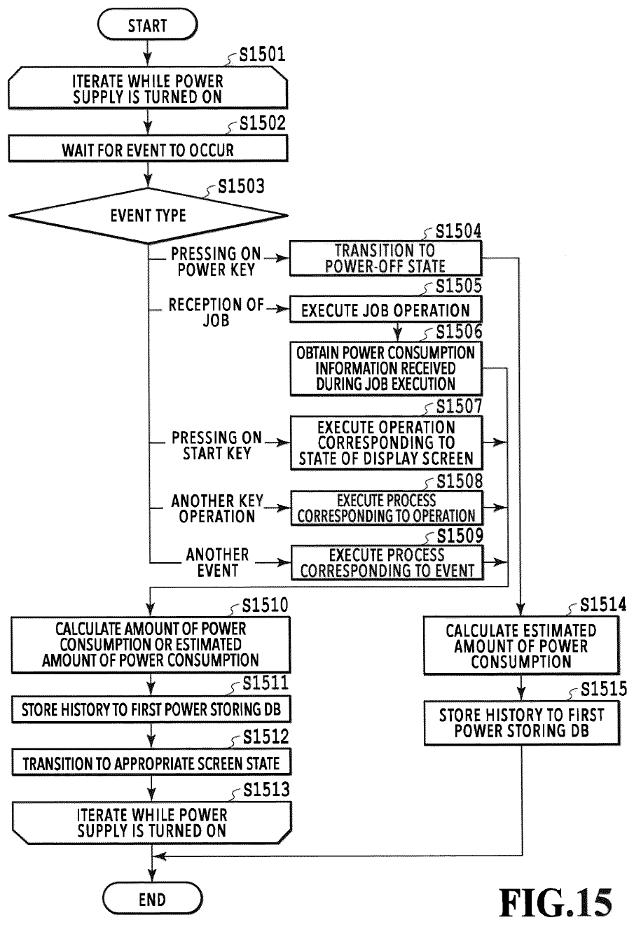

FIG. 15 is a flowchart illustrating contents of processing by the CPU 211 of the printer 130 in the configuration in FIG. 13. The CPU 211 of the printer 130 executes this processing in a case where the power supply of the printer 130 gets turned on, and iterates the processes of S1501 to S1513 while the power supply of the printer 130 is turned on. In S1502, which is the first step in an iteration loop, the CPU 211 of the printer 130 waits for an event to occur. In a case where it is detected in S1502 that an event has occurred, the processing proceeds to S1503.

In S1503, the CPU 211 performs the processing corresponding to the type of the occurring event. In a case where the occurring event was a press on a power key provided on the operation panel 203 in S1503, the processing proceeds to S1504, in which the printer 130 transitions to the power-off state from the power-on state. As a result, the processing exits the iteration loop, the processing of S1514 and S1515 to be described later is performed, and the printer 130 enters a dormant state until the power supply is turned on next time. In a case where the occurring event was reception of an instruction to execute a job, such as a print job or a scan job, from an external apparatus in S1503, the processing proceeds to S1505, in which an operation corresponding to the contents of the received job is executed.

In S1506, the CPU 211 obtains power consumption information of the print job as the amount of power consumption of the print job from the PC 140, and calculates the amount of power consumption excluding the print job. That is, the amount of power consumption of the job, such as the print job or the scan job, whose amount of power consumption varies according to the contents of its processing, is obtained.

In a case where the occurring event was a press on a start key provided on the operation panel 203 in S1503, the processing proceeds to S1507, in which the operation based on settings displayed on the display screen is executed. Here, assume that the scan job or the copy job is executed. In a case where the occurring event was the operation on the operation panel 203 in S1503, the processing proceeds to S1508, in which the processing corresponding to the panel operation is executed. In a case where the occurring event was another event in S1503, the processing proceeds to S1509, in which the processing corresponding to the occurring event is executed. After the processing corresponding to the occurring event is completed in the processing of one of S1506 to S1509, the processing proceeds to S1510.

In S1510, the CPU 211 obtains the amount of power consumption of the received job or the operation executed in S1507, and calculates an estimated amount of power consumption corresponding to the occurring event. In S1511, the CPU 211 stores the obtained amount of power consumption and the calculated estimated amount of power consumption to the first power storing DB 850 in the non-volatile memory 215 as history information. In S1512, the CPU 211 determines the display screen to which to transition based on the combination of the screen currently displayed on the operation panel 203 and the received job or the occurring event, and the display screen transitions to the determined screen.

In S1514, the CPU 211 calculates the estimated amount of power consumption corresponding to the occurring event. In S1515, the CPU 211 stores the estimated amount of power consumption to the first power storing DB 850 in the non-volatile memory 215 as history information, and terminates the processing in the flowchart illustrated in FIG. 15.

According to the present embodiment, the PC 140 can calculate the amount of power consumption of the print job and transmit the calculated amount of power consumption of the print job to the printer 130. That is, it is possible to reduce the load on the printer 130.

### Third Embodiment

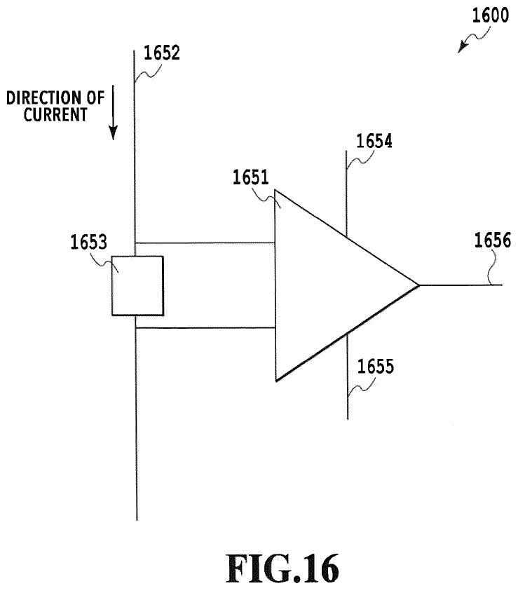

In a third embodiment, a method of calculating the actual amount of power consumption using an electrical circuit will be described. An electrical circuit configuration as a measurement unit (measurement circuit) that calculates the amount of power consumption, and an operation flow will be mainly described. Description of the contents already described in the first and second embodiments will be omitted. FIG. 16 is a diagram illustrating an electrical circuit configuration 1600 for measuring the amount of power consumption of the printer 130 which varies according to its operation status. This electrical circuit configuration 1600 is installed on each power supply line where the amount of power consumption is to be measured. The electrical circuit configuration 1600 includes an operational amplifier 1651, a power supply line 1652 where a current value is to be detected, a resistor 1653 forming a detection circuit, a driving power supply 1654 for the operational amplifier 1651, a ground connection 1655, and a signal line 1656 for reading out the detected current value. The signal line 1656 may be connected to an ASIC and used to calculate the amount of power consumption.

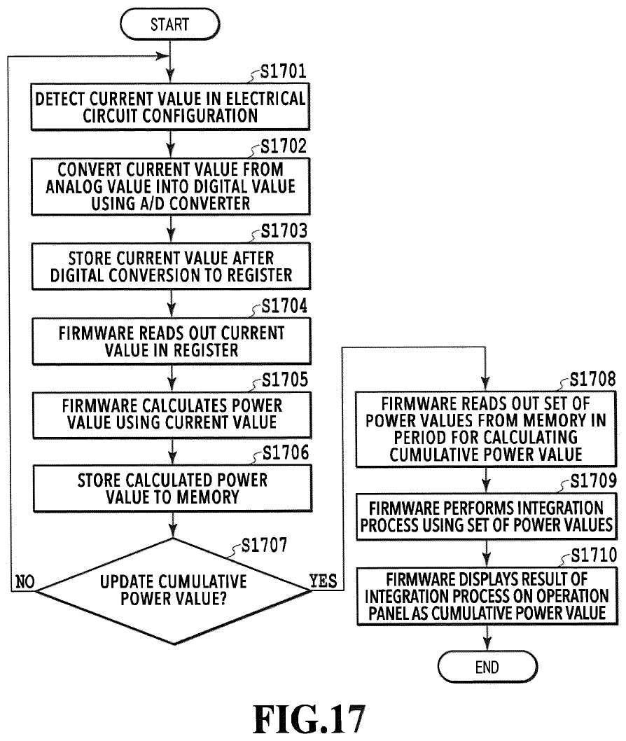

FIG. 17 is a flowchart illustrating contents of processing for calculating the amount of power consumption of the printer 130 which varies according to its operation status by using an electrical circuit. In S1701, a current value is detected using the electrical circuit configuration 1600 included in the electrical circuit. Details of the electrical circuit configuration 1600 are illustrated in FIG. 16. In S1702, the current value detected in S1701 is converted from an analog value into a digital value using an AD converter. As the AD converter, one that is incorporated in an ASIC may be used. In S1703, the current value after the digital conversion process is stored to a firmware readable register. As the register, one incorporated in an ASIC may be used.

In S1704, firmware reads out the current value stored in the register. In S1705, the firmware calculates the power value using the read current value. The power value is calculated using the current value and a voltage value (fixed value) at the part where the electrical circuit configuration 1600 is installed. In S1706, the firmware stores the calculated power value to the memory. The power calculation unit described above may access the above memory and obtain the power value measured by the electrical circuit configuration 1600 and calculate the amount of power consumption of the job for which the estimated amount of power consumption is unknown, for example.

In S1707, the firmware determines whether to update the cumulative power value. In a case where the firmware determines not to update the cumulative power value, the processing returns to S1701, and the processes of S1701 to S1706 are iterated to calculate the present power value again. In a case where the firmware determines to update the cumulative power value, the processing proceeds to S1708.

In S1708, the firmware reads out the plural power values in the calculation period for the cumulative power value from the memory. For example, in a case of calculating the cumulative power value for the past one week, the firmware reads out, for example, the power values in the past one week from the memory. In S1709, the firmware performs integration process using the plural power values thus read out. In S1710, a cumulative power value is calculated using the result of the integration process executed in S1709, and the calculated cumulative power value is displayed on the operation panel 203.

The above description is about the amounts of power consumption of the print jobs, but the amounts of power consumption of the scan jobs, the copy jobs, or the like can be calculated in a similar manner. Also, the electrical circuit configuration 1600 may be installed at plural portions. The firmware may derive the sum of the power values of the plural electrical circuit configurations 1600 and calculate the cumulative amount of power consumption of the print jobs, the scan jobs, the copy jobs, or the like.

According to the present embodiment, the amount of power consumption can be accurately calculated based on the measurement by the electrical circuit configuration 1600. Also, by letting the user confirm the amount of power consumption displayed and change various settings, the amount of power consumption can be reduced.

### Fourth Embodiment

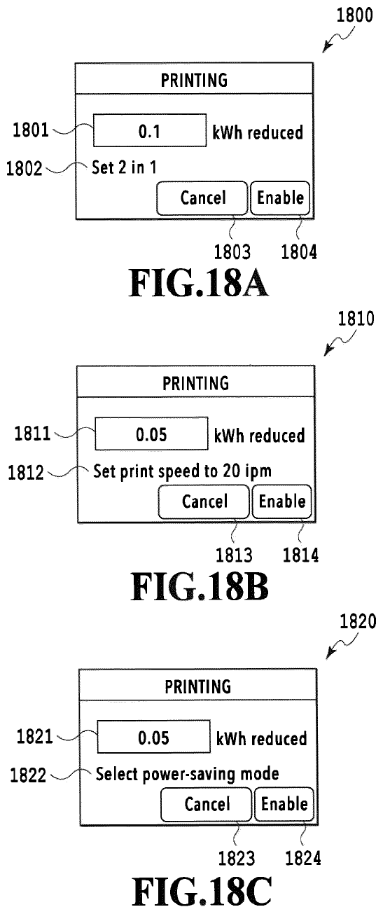

FIGS. 18A to 18C illustrate examples of a setting change screen displayed at the start of the print job in a fourth embodiment. The setting change screen may be displayed on the operation panel 203 of the printer 130 or displayed on various UIs of the PC 140. FIG. 18A prompts the user to enable “Set 2 in 1” as illustrated in a region 1802 as a print setting. The user can select an enable button 1804 or a cancel button 1803 on a display UI 1800. “Set 2 in 1” is a suggestion to reduce the area in the image to which to eject the inks. Other possible methods for reducing the area include changing a rendering setting. For example, an object depicted entirely in a uniform color in a graphic region on a screen may be presented as a hatched region by changing the rendering setting. In this way, the inks will be ejected onto discrete positions, thus reducing the total area of ink ejection. A UI setting content, such as “Change graphic object rendering settings”, can be displayed to prompt the user to enable the setting. Display UIs for changing other control settings related to ejection can prompt the user to change the settings in a similar manner. Pressing the enable button 1804 in FIG. 18A displays the effect of “Set 2 in 1” on the power consumption in a region 1801. The above has described an example with “2 in 1” but the present embodiment is not limited to this. The present embodiment also includes a case of printing two or more pages on one sheet.

FIG. 18B prompts the user to enable “Set print speed to 20 ipm” as illustrated in a region 1812 as a print setting. “Set print speed to 20 ipm” illustrated in the region 1812 is equivalent to lowering the scan speed of the print head in a case where the normal print speed is 40 ipm. The user can select an enable button 1814 or a cancel button 1813 on a display UI 1810. The above is a suggestion for reducing the power consumption by a motor in the printing of the image. Reducing the number of times to scan the print head in the sheet width direction is effective in reducing the amount of power consumption. The power used by the main body of the printer includes power for ejecting the inks as well as power for driving the print head and power for conveying sheets. Hence, the user can be prompted to enable a setting that reduces the amount of ejection of the ink as a similar suggestion. A UI setting content, such as “Reduce inks (the amount of color materials)”, can be displayed to prompt the user to enable the setting. Also, the means for reducing the amount of ejection is not limited to this. For example, prompting the user to enable settings such as “Switch to monochrome printing from color printing,” “Print with UCR (Under Color Removal)”, and the like is effective in lowering the ink consumption and reducing the amount of power consumption. Pressing the enable button 1814 in FIG. 18B displays an achieved value representing the reduction in the amount of power consumption achieved by “Set print speed to 20 ipm” in a region 1811. That is, an achieved value representing the reduction in power achieved by making the setting change is displayed on the setting change screen.

FIG. 18C prompts the user to enable “Select power-saving mode” as illustrated in a region 1822 as a print setting. “Select power-saving mode” indicated in the region 1822 can collectively enable one or more settings that have already been defined as a recommended mode for power saving without having the user select which setting items to enable individually. The user can select an enable button 1824 or a cancel button 1823 on a display UI 1820. For example, enabling “Select power-saving mode” will reduce the inks and set the print speed to 20 ipm. This can lower both the power required for the ink ejection and the power required for the head driving and also reduce the burden on the user for configuring settings. Such ink ejection amounts and print speed can be achieved by, for example, setting a high-speed print mode as a user UI setting for the amounts of the inks and setting a fine print mode as a user UI setting for the print speed. Pressing the enable button 1824 in FIG. 18C displays an achieved value representing the reduction in the amount of power consumption achieved by “Select power-saving mode” in a region 1821.

The above has described an example with the print job. With the scan job or the copy job too, a display as a guide to a mode for reducing the amount of power consumption may be displayed in a similar manner on a setting screen displayed at the start of the scan job or the copy job. With the scan job or the copy job too, the achieved value representing the reduction in power achieved by making a setting change may be displayed on the setting screen. That is, the achieved value representing the reduction in power achieved by making the setting change is displayed on the setting screen. By configuring the settings of the printer 130 described above, the amount of power consumption can be reduced.

### Fifth Embodiment

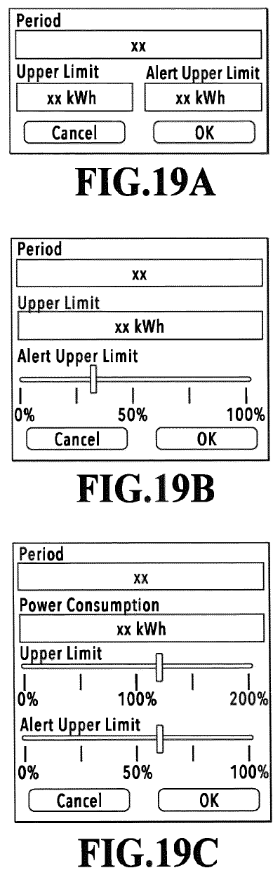

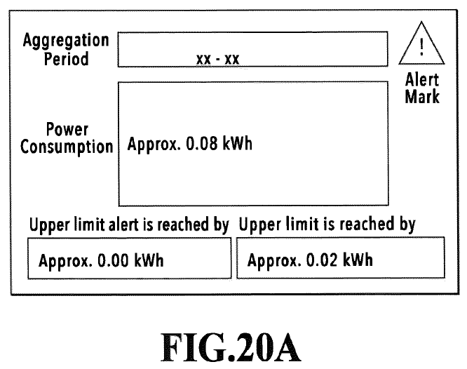

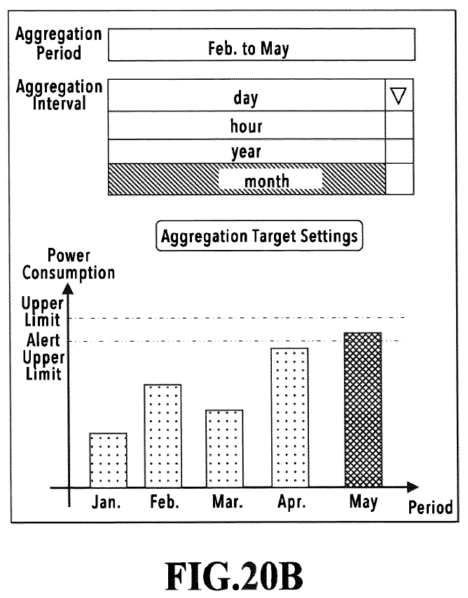

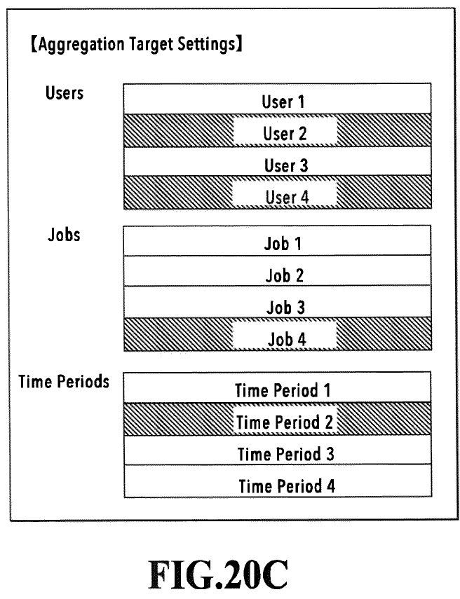

In the fourth embodiment, guidance to reducing power consumption has been described. This, however, imposes a high burden on the user as the user must use the printer 130 while being constantly aware of the amount of power consumption of the executed process against a power value that is considered acceptable to be consumed within a predetermined period (hereinafter referred to as “power consumption upper limit”). In view of this, a fifth embodiment will describe examples of a screen on which the power consumption upper limit is set and a screen on which the amount of power consumption is displayed. Note that the screens illustrated in FIGS. 19A to 19C are UI screens reached by transitioning from power consumption display settings 918 in FIG. 9. The screens illustrated in FIGS. 20A to 20C are UI screens reached by transitioning from the screens illustrated in FIGS. 19A to 19C.

The user opens any of the screens illustrated in FIGS. 19A to 19C, and sets the power consumption upper limit and the power value at which an alert is displayed as the power consumption upper limit is likely to be exceeded therefrom (hereinafter referred to as “alert upper limit”). Hereinafter, the screens illustrated in FIGS. 19A to 19C will also be referred to as “threshold setting screens.” Each threshold setting screen may be displayed on the operation panel 203 of the printer 130 or displayed on various UIs of the PC 140.

The following methods are conceivable for setting the power consumption upper limit and the alert upper limit. For example, the methods include one in which values are directly set (FIG. 19A), one in which the alert upper limit is set with a slider bar relative to the power consumption upper limit (FIG. 19B), one in which the power consumption upper limit and the alert upper limit are set with respective slider bars relative to average power consumption (FIG. 19C), and so on.

The user opens any of the screens illustrated in FIGS. 20A to 20C and checks the power consumption and power consumption upper limit. Hereinafter, the screens illustrated in FIGS. 20A to 20C will also be referred to as “power consumption check screens.” Each power consumption check screen may be displayed on the operation panel 203 of the printer 130 or displayed on various UIs of the PC 140. Conceivable power consumption check screens include a screen directly displaying values (FIG. 20A), a screen displaying a graph (FIG. 20B), and so on. Conceivable methods of presenting an alert in a case where the alert upper limit is exceeded during display include displaying an alert mark (FIG. 20A), changing the depiction method in the graph (FIG. 20B). Also, the power consumption aggregation period, interval, targets, and the like can be changed as well (see FIG. 20B). The power consumption aggregation interval is set based on the user's designation, and may be a yearly, monthly, weekly, daily, or hourly basis. Also, the power consumption aggregation period is set based on the user's designation as well. The method of designating the aggregation period may be linked to a calendar. This allows the user to aggregate the power consumption in synchronization with business days, holidays, closing dates, and the like. The power consumption in the past can be aggregated and displayed according to the set power consumption aggregation period. Alternatively, the power consumption aggregation targets can be set for individual print jobs, users, and time periods designated by the user (see FIG. 20C). Also, jobs, users, and time periods with high power consumption or the like can be displayed as the aggregation targets. In a case where the alert upper limit is exceeded, the printing method described in the fourth embodiment is displayed on the operation panel 203 or this printing method is set. A mode for lowering the amount of ink consumption or a mode for executing maintenance only for the inks to be used may be a method other than the printing method described in the fourth embodiment. The amount of ink consumption may be set to any amount by the user. In this way, a use method that does not exceed the power consumption upper limit can be provided to the user.

### Other Embodiments

In the above-described embodiments, examples in which numerical values and setting values to be displayed are calculated with power consumption as an index have been described. Alternatively, the configuration may be such that an index other than power consumption is used. For example, the configuration may be such that the amount of carbon dioxide emission is used as an index, instead of power consumption. In this case, the configuration can be such that not only the aggregated and calculated power consumption is converted into an amount of carbon dioxide emission but also the amounts of consumables, such as the inks and the print sheets used in printing, are converted into amounts of carbon dioxide emission and used as indexes. In the fourth embodiment, guidance to reducing power consumption has been described. Guidance to reducing the amount of carbon dioxide emission may be provided. For example, the user may be prompted to enable “Set double-sided printing”. This can reduce the paper consumption, which can lead to a reduction in the amount of carbon dioxide emission.

In the above-described embodiments, examples of reducing the power consumption of a single printer have been described. However, the embodiments may be applied to a system that use plural printers. For example, continuously performing the print jobs can reduce the power consumption per page as compared to intermittently performing the print jobs. This is because, without a time interval, the head temperature will be maintained and the cap closing control during standby can be omitted. Thus, in a case where the user executes the print job, the recommended printer taking power consumption into account may be presented by a driver on the operation panel of the printer, the UI screen of the PC, or the like. Alternatively, in a case where the printer regularly gets activated and performs maintenance, such as ink circulation, even in a power-saving state, the printer with short times until the next activation time for the regular maintenance may be presented as the recommended printer on the operation panel of the printer, the UI screen of the PC, or the like. Then, the print job may be input into this printer. In the above, an example of presenting the recommended printer taking recent power consumption into account. Alternatively, a recommended time period to input the print job for each printer may be presented on the operation panel of the printer, a UI screen of the PC, or the like. Specifically, in a case where the print setting button 421 for displaying the amount of power consumption of the print job is pressed, a printing state power setting screen not illustrated is displayed, and a recommended print job input time period is displayed on this power setting screen. Also, before executing the print job, information such as the amounts of power consumption and ink consumption of each printer to which to input the print job, the time required for the printing, estimated operation noise, and so on may be presented as information that helps the user select the printer on the operation panel of the printer, the UI screen of the PC, or the like.

For the scan job too, the recommended printer taking power consumption into account may likewise be presented by a driver on the operation panel of the printer, the UI screen of the PC, or the like. The recommended time period to input the scan job for each printer may be presented on the operation panel of the printer, the UI screen of the PC, or the like. Specifically, in a case where a scan setting button not illustrated for displaying the amount of power consumption of the scan job is pressed, a scanning state power setting screen not illustrated is displayed, and a recommended scan job input time period is displayed on this power setting screen.

In the above-described embodiments, examples for reducing power consumption have been presented. In addition to the presented examples, the power consumption during the standby state can be reduced by setting intermittent reception for wireless communication. Also, depending on the usage of the printer by the user, the power consumption during the standby state can be reduced by lengthening the time interval between regular maintenance operations. In addition, for a user who mainly uses the printer for printing via a driver, the power consumption during the standby state can be reduced by shortening the operation panel's tum-off time.

As described above, it is possible to present information on the amounts of power consumed by an image processing apparatus.

The present disclosure can also be implemented through processing including supplying a program for implementing one or more functions of the embodiments described above to a system or an apparatus by using a network or a storage medium, and reading and executing, by a computer of the system or the apparatus, the program. The computer includes one or a plurality of processors or circuits, and may include a network of a plurality of individual computers or a plurality of individual processors or circuits, to read and execute a computer-readable instruction.

The processor or circuit may include a central processing unit (CPU), a micro processing unit (MPU), a graphics processing unit (GPU), an application specific integrated circuit (ASIC), or a field-programmable gate array (FPGA). Moreover, the processor or circuit can include a digital signal processor (DSP), a data flow processor (DFP), or a neural processing unit (NPU).

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-170265, filed Sep. 30, 2024, which is hereby incorporated by reference herein in its entirety.

What is claimed is:

1. An image processing apparatus, comprising one or more processors and/or circuitry which function as:
an obtaining unit configured to obtain a cumulative amount of power consumption for each of job types in a predetermined period; and
a display control unit configured to display the cumulative amount of power consumption for each of the job types obtained by the obtaining unit on a display device.

2. The image processing apparatus according to claim 1, wherein the obtaining unit obtains the cumulative amount of power consumption for each of the job types by accumulating the amount of power consumption for each of the jobs executed in the predetermined period, for each of the job types.

3. The image processing apparatus according to claim 2, wherein the job is a print job or a scan job.

4. The image processing apparatus according to claim 3, wherein the obtaining unit obtains the amount of power consumption for each of the jobs based on a power consumption amount table corresponding to each of the jobs.

5. The image processing apparatus according to claim 3, wherein the obtaining unit obtains the amount of power consumption for each of the jobs based on an amount of power consumption measured by a measurement circuit.

6. The image processing apparatus according to claim 5, wherein the measurement circuit is installed at a plurality of positions.

7. The image processing apparatus according to claim 4, wherein, in a case where the print job is executed, the obtaining unit obtains the amount of power consumption for each of the jobs based on printing density or a dot count in the printing.

8. The image processing apparatus according to claim 4, wherein, in a case where the scan job is executed, the obtaining unit obtains the amount of power consumption for each of the jobs based on contents of a process of correcting blur resulting from scanning, a process of removing a paper white portion, and a color conversion process corresponding to a color gamut for display.

9. The image processing apparatus according to claim 1, wherein the display control unit displays, on the display device, a user interface screen indicating the cumulative amount of power consumption for each of the job types.

10. The image processing apparatus according to claim 9, wherein
the user interface screen has buttons for displaying details of the amount of power consumption for each of the job types, and
in a case of receiving a press on one of the buttons for displaying the details of the amount of power consumption for each of the job types, the display control unit transitions to a history list screen for the job corresponding to the pressed button.

11. The image processing apparatus according to claim 10, wherein, in a case where a history of the job is selected from the history list screen for the job by a user operation, the display control unit transitions to a screen displaying the amount of power consumption of the selected job.

12. The image processing apparatus according to claim 3, wherein, in starting the print job, the display control unit displays, on the display device, a setting change screen for the print job including a content as a guide to a mode for reducing the amount of power consumption.

13. The image processing apparatus according to claim 12, wherein the display control unit displays an achieved value representing a reduction in power to be achieved by making a setting change on the setting change screen for the print job.

14. The image processing apparatus according to claim 12, wherein the mode for reducing the amount of power consumption includes:
a mode in which a plurality of pages are printed on a single sheet;
a mode in which a print speed is changed;
a mode in which monochrome printing is set from color printing;
a mode in which printing is performed with under color removal; and
a mode in which a color material is reduced.

15. The image processing apparatus according to claim 3, wherein, in starting the scan job, the display control unit displays, on the display device, a setting change screen for the scan job including a content as a guide to a mode for reducing the amount of power consumption.

16. The image processing apparatus according to claim 15, wherein the display control unit displays an achieved value representing a reduction in power to be achieved by making a setting change on the setting change screen for the scan job.

17. A method of controlling an image processing apparatus, comprising:
obtaining a cumulative amount of power consumption for each of job types in a predetermined period; and
displaying the cumulative amount of power consumption for each of the job types obtained in the obtaining on a display device.

18. A non-transitory computer readable storage medium storing a program which causes a computer to execute a method of controlling an image processing apparatus, the method comprising:
obtaining a cumulative amount of power consumption for each of job types in a predetermined period; and
displaying the cumulative amount of power consumption for each of the job types obtained in the obtaining on a display device.
